(19) United States
(12) Patent Application Publication
(10) Pub. No.: US 2013/0102714 A1
(43) Pub. Date: Apr. 25, 2013

(54) Rubber Mixture

(71) Applicant: Continental Reifen Deutschland GmbH, Hannover (DE)

(72) Inventors: Carla Recker, Hannover (DE); Torsten Riechers, Hannover (DE); Lena Mueller, Raddestorf (DE); Thomas Kramer, Herford (DE); Katharina Herzog, Harsum (DE); Philipp Koelle, Stuttgart (DE)

(73) Assignee: CONTINENTAL REIFEN DEUTSCHLAND GMBH, Hannover (DE)

(21) Appl. No.: 13/718,627

(22) Filed: Dec. 18, 2012

Related U.S. Application Data
(63) Continuation of application No. PCT/EP2011/058888, filed on May 31, 2011.

(30) Foreign Application Priority Data
Jul. 8, 2010 (DE) 10 2010 017 805.5

(51) Int. Cl. C08K 5/548; C08K 3/04

(52) U.S. Cl. CPC C08K 5/548; C08K 3/04
USPC 524/262

(57) ABSTRACT

A rubber mixture, in particular for vehicle pneumatic tires, straps, belts and hoses. The rubber mixture includes the following constituents: at least one synthetic diene rubber; at least one carbon black; at least one silane; and, at least one amphophilic compound. The rubber mixture ameliorates the target conflict between rolling resistance and wet grip.

### CROSS REFERENCE TO RELATED APPLICATIONS

This application is a continuation application of international patent, application PCT/EP2011/058888, filed May 31, 2011, designating the United, States and claiming priority from German application 10 2010 017 305.5, filed Jul. 8, 2010, and the entire content of both applications is incorporated herein by reference.

### FIELD OF THE INVENTION

The invention relates to a rubber mixture, in particular for pneumatic tires, straps, belts and hoses.

### BACKGROUND OF THE INVENTION

Various measures are known, to persona skilled in the art for optimizing the physical properties of a rubber mixture used by way of example in pneumatic tires or in industrial rubber items, such as drive belts and other belts, and hoses: many different attempts have been made to influence tire properties favorably by varying the polymer components; and the other additives in the tread mixture. Examples that may be mentioned at this point for additives are fillers, for example, carbon black and silica, and others, plasticizers, antioxidants, and crosslinking systems made of sulfur, accelerator, and activator. However, when one property is improved by varying the mixture, there is frequently attendant impairment of another property, and there are therefore certain conflicts of objective here. A particular property that is significant not only for pneumatic tires but also for industrial rubber items is roiling resistance. However, an improvement in rolling resistance here necessarily leads to impairment of other physical properties of the vulcanizates, for example, wet grip and/or elongation at break. JP2007291218A discloses by way of example use of a specific surfactant substance for this purpose in rubber mixtures comprising silica as filler and silane. KR1019360007760B1 proposes another specific surfactant substance for improving the dispersion of the polar filler (silica) in a nonpolar polymer. The intention here is likewise to improve the physical properties of the silica-containing rubber mixture. Since carbon black is a nonpolar filler, the assumption hitherto has been that the use, in predominantly carbon-black-containing rubber mixtures, of the type of additional mixture components that is used in rubber mixtures which comprise predominantly polar fillers has no effect on the dispersion of the carbon black.

### SUMMARY OP THE INVENTION

It is therefore an object of the invention to provide a rubber mixture which in particular comprises carbon black as filler and which resolves or at least mitigates the conflict of objectives between rolling resistance and wet grip without any impairment of the other physical properties, in particular the properties relating to elongation at break.

The object is achieved by providing a rubber mixture which comprises at least one synthetic diene rubber and at least one carbon black, and at least one silane, and at least one amphiphilic compound.

Surprisingly, it has been found that a rubber mixture of this type has optimized rolling resistance, without any impairment of the other physical properties, such as wet grip or elongation at break. The combination of at least one silane and of at least one amphiphilic compound in a carbon-black-containing rubber mixture leads to improved dispersion of the carbon black in synthetic diene rubbers, and this is in turn reflected in the abovementioned advantages,

The phr (parts per hundred parts of rubber by weight) data which are used in this specification are the conventional quantitative data for mixture formulations in the rubber industry. The amount of the individual substances added in parts by weight here is always based on 100 parts by weight of the entire composition of ail of the rubbers present in the mixture.

The rubber mixture comprises at least one synthetic diene rubber.

This is preferably one selected from the group consisting of synthetic polyisoprene and/or butadiene rubber and/or styrene-butadiene rubber and/or solution-polymerized styrene-butadiene rubber and/or emulsion-polymerized styrene-butadiene rubber, and particularly good properties are achieved here when a solution-polymerized styrene-butadiene rubber is used.

In one particular embodiment, the solution-polymerized styrene-butadiene rubber can have been hydrogenated and/or can have been modified with hydroxy groups and/or epoxy groups and/or siloxane groups and/or amino groups and/or aminosiloxane and/or carboxy groups and/or phthalocyanine groups. However, it is also possible to use ether modifications, also termed functionalizations, known to the person skilled in the art.

The amounts used of the synthetic diene rubber are preferably from 10 to 100 phr, particularly preferably from 30 to 100 phr, very particularly preferably from 50 to 100 phr.

However, there can also be other polar or nonpolar rubbers present in the rubber mixture, for example natural polyisoprene and/or liquid rubbers and/or halobutyl rubber and/or polynorbornene and/or isoprene-isobutylene copolymer and/or ethylene-propylene-diene rubber and/or nitrile rubber and/or chloroprene rubber and/or acrylate rubber and/or fluoro rubber and/or silicone rubber and/or polysulfide rubber and/or epichlorohydrin rubber and /or styrene-isoprene-butadiene terpolymer and/or hydrogenated acrylonitrile-butadiene rubber and/or isoprene-butadiene copolymer and/or hydrogenated styrene-butadiene rubber.

Materials particularly used for producing industrial rubber items, such as belts, straps and hoses, are nitrile rubber, hydrogenated acrylonitrile-butadiene rubber, chloroprene rubber, butyl rubber, halobutyl rubber or ethylene-propylene-diene rubber.

Amounts that can preferably be used of the other rubber are from 0 to 20 phr, particularly from 0 to 10 phr.

The rubber mixture of the invention moreover comprises at least one carbon black. The amounts used of the carbon black are preferably from 1 to 100 phr, particularly preferably from 10 to 80 phr, and very particularly preferably from 20 to 70 phr. In one particularly preferred embodiment, the iodine number of the carbon black in accordance with ASTM D1510, also known as iodine absorption number, is greater than or equal to 75 g/kg, and its DBP number is greater than or equal to 30 cm³/100 g. For the DBP number in accordance with the ASTM D2414, dibutyl phthalate is used to determine the specific absorption volume of a carbon black, or of a pale-colored filler.

The use of this type of carbon black in the rubber mixture, in particular for pneumatic tires, ensures an optimum compromise between abrasion resistance and heat generation, which in turn affects the environmentally relevant property of rolling resistance. It is preferable here to use only one type of carbon black in the respective rubber mixture, but it is also possible to mix various types of carbon black into the rubber mixture.

Another possibility, furthermore, is that the rubber mixture of the invention also comprises at least one pale-colored filler. It is preferable that the pale-colored filler is silica, preferably precipitated silica. Any of the silicas known to the person skilled in the art can be used here.

It is essential to the invention that the rubber mixture comprises at least one silane and at least one amphiphilic compound. Only then are the advantages in respect of rolling resistance apparent without disadvantages in wet grip or in other physical properties, in particular in elongation at break. Preferred amounts used of the silane, also termed organosilicon compound, are from 0.3 to 5 phr, particularly from 0.3 to 3 phr, very particularly from 0.3 to 2 phr. Any of the silanes that are known to the person skilled in the art and are conventional in the rubber industry can be used.

Mercaptosilanes are particularly advantageous here, in particular unblocked mercaptosilanes or mercaptosilanes that are only partially blocked.

Mercaptosilanes of this type are obtainable by way of example with trade name Si263 or Si363 from Evonik Industries. However, it is also possible to use the silanes obtainable with trade name NXT-Z from Momentive Performance Materials Inc.

The rubber mixture of the invention comprises at least one amphiphilic compound and specifically preferably in amounts from 0.5 to 10 phr, particularly preferably from 0.5 to 5 phr, very particularly preferably from 1 to 3 phr.

An amphiphilic compound of this type can be an anionic surfactant, or a nonionic surfactant, or a cationic surfactant, or an amphoteric surfactant, or a block copolymer. The amphiphilic compounds mentioned can foe used here alone or in combination.

Anionic surfactants used, can by way of example comprise soaps, alkylbenzenesulfonates, alkanesulfonates, alkyl sulfates, or fatty alcohol polyglycol ether sulfates. Examples of nonionic surfactants are fatty alcohol polyglycol ethers, alkylphenol polyglycol ethers, (ethoxylated) sorbitan fatty acid esters, alkyl polyglucosides, fatty acid, glucamides, fatty acid ethoxylates, ethylene oxide-propylene oxide block polymers, polyglycerol fatty acid esters, fatty acid alkanolamides, and amine oxides.

An example of cationic surfactants that can be used are quaternary ammonium compounds having one or two hydrophobic groups, or salts of long-chain primary amines, while amphoteric surfactants that can be used comprise N-(acylamidoalkyl)betaines and N-alkyl-β-aminopropionates.

Amphiphilic compounds of this type are obtainable inter alia with trade names Brij®, Struktoi WB/KW/AW, Lutensol®, Pluronic® or Tween®.

It is particularly preferable that the block copolymer is a poloxamer and that the nonionic surfactant is a polyoxyethylene fatty acid ester. Particularly good properties are apparent here in relation to mitigation of the conflict of objectives between rolling resistance and wet grip.

Moreover, the rubber mixture also comprises other additional materials.

Other additional materials in essence include the crosslinking system (crosslinking agent, sulfur donor and/or elemental sulfur, accelerator, and retarder), antiozonant, antioxidant, mastication aid, and other activators. The quantitative proportion of the entire amount of other additional materials is from 3 to 150 phr, preferably from 3 to 100 phr, and particularly preferably from 5 to 80 phr.

For use in pneumatic tires, the rubber mixture is preferably vulcanised in the presence of elemental sulfur or of sulfur donors, and some sulfur donors here can act simultaneously as vulcanisation accelerators. Elemental sulfur or sulfur donors are added to the rubber mixture in the final mixing step, in the amounts familiar to the person skilled in the art (from 0.4 to 10 phr, elemental sulfur preferably in amounts of from 0 to 6 phr, particularly preferably from 0.1 to 4 phr). In order to control the time and/or temperature required for vulcanization, and in order to improve the properties of the vulcanizate, the rubber mixture can comprise substances that influence vulcanization, for example vulcanization accelerators, vulcanization retarders, and vulcanisation activators, where these are comprised within the additional materials described above.

The rubber mixture of the invention advantageously comprises from 0.1 to 6 phr, preferably from 1 to 5 phr, of at least one vulcanization accelerator.

The vulcanisation accelerator is preferably one selected from the group of the sulfonamide accelerators and/or thiazole accelerators and/or thiuram accelerators and/or mercapto accelerators and/or dithiocarbamate accelerators and/or amine accelerators and/or dithiophosphates and/or thioureas, preference being given to sulfenamide accelerators here.

Benzothiazyl-2-cyclohexylsulfenamide (CBS) is preferably used as sulfenamide accelerator.

The rubber mixture of the invention is typically produced by the process conventional in the rubber industry, where a parent mixture with all of the constituents other than the vulcanization system (for example, sulfur and substances that influence vulcanization) is first produced in one or more mixing stages.

The finished mixture is produced by adding the vulcanization system in a final mixing step. By way of example, an extrusion procedure is used to further process the finished mixture and to convert it to the appropriate form.

However, it has been found to be very advantageous to produce the rubber mixture of the invention by a process in which at least one synthetic diene rubber, at least one silane, at least one carbon black, and at least one amphophilic compound are mixed with one another in a first mixing stage, in a mixer. All of the other mixture constituents are added in one or more subsequent mixing stages.

Another object, of the invention is to use the rubber mixture described above for producing tires, in particular for producing the tread of a tire and/or a body mixture of a tire, and for producing drive belts and other belts, and hoses.

The tire can be a truck tire, a car tire, or a tire for a two-wheeled vehicle. However, it is preferable to use the rubber mixture of the invention in a truck tire, and specifically preferably as rubber mixture for the tread therein.

The expression body mixture of a tire is in essence used for the rubber mixtures for side wall, inner lining, apex, belt, shoulder, belt profile, squeegee, carcass, bead reinforcement, and/or a solid tire.

For use in pneumatic tires, the mixture is preferably converted to the form of a tread and applied in known manner during the production of a green tire. However, the tread can also be wound in the form of a narrow strip of rubber mixture onto a green tire. If, as described in the introduction, the tread has two or more parts, the rubber mixture is preferably used as a mixture for the cap.

The rubber mixture of the invention for use as body mixture in tires is produced as described above for the tread. The difference lies in the shaping after the extrusion procedure. The resultant forms of the rubber mixture of the invention for a body mixture, or for a plurality of different body mixtures, then serve for the construction of a green tire. For use of the rubber mixture of the invention in drive belts and other belts, in particular in conveyor belts, the extruded mixture is converted to the appropriate form and thereby or subsequently often provided with reinforcement materials, for example, synthetic fibers or steel cord. The result of this is mostly a. multiple-ply structure, composed of one or more plies of rubber mixture, one or more plies of identical or different reinforcement materials, and one or more further plies of the same and/or another rubber mixture.

For use of the rubber mixture of the invention in hoses, preference is often given to peroxidic crosslinkers rather than what are known as sulfur crosslinkers. The hoses are mostly produced by analogy with the process described in Handbuch der Kautschuktechnologie [Handbook of rubber technology], Dr. Gupta. Vexlag, 2001, chapter 13.4.

### DESCRIPTION OF THE PREFERRED EMBODIMENTS OF THE INVENTION

Comparative and inventive examples, collated in Tables 1to 5, will now be used for further explanation of the invention. The mixtures identified here by “I”involve mixtures of the invention, while the mixtures identified by “C” involve comparative mixtures. The tables identified by “a” here describe the composition of the mixture, while the tables identified by “b” illustrate the appropriate associated physical properties.

In all of the mixture examples in the tables, the quantitative data stated are parts by weight, based on 100 parts by weight of all rubber(s) (phr).

The mixtures were produced under conventional conditions in a plurality of stages in a laboratory tangential mixer. Test specimens were produced by vulcanization from ail of the mixtures, and the test specimens were used to determine properties typical, of the rubber industry. The test methods used for the tests described above on test specimens were as follows:
Rebound resilience at room temperature and 700° C. in accordance with DIM 53 512
Mooney viscosity (ML 1+4) at 100° C. in accordance with ASTM D1646
Shore A hardness at room temperature in accordance with DIN 53 505
Stress value at 50% elongation at room temperature in accordance with DIN 53 504
Elongation at break at room temperature in accordance with DIN 53 504
Loss factor tan d, synonymous with tan δ, at 55° C. from dynamic-mechanical measurement in accordance with DIN 53 513

TABLE 1a

| Constituents | Unit | C1 | I1 | C2 | I2 |
|---|---|---|---|---|---|
| Styrene-butadiene rubber^{a} | phr | — | — | 100 | 100 |
| Styrene-butadiene rubber^{b} | phr | 100 | 100 | — | — |
| Carbon black^{c} | phr | 70 | 70 | 70 | 70 |
| Amphiphilic compound^{d} | phr | — | 2 | — | 2 |
| Silane^{e} | phr | — | 0.7 | — | 0.7 |
| Plasticizer^{f} | phr | 25 | 25 | 25 | 25 |
| Zinc oxide | phr | 2.5 | 2.5 | 2.5 | 2.5 |
| Reinforcement resin^{g} | phr | 11 | 1 | 1 | 1 |
| Additional materials^{h} | phr | 4.5 | 4.5 | 4.5 | 4.5 |
| Sulfenamide acceleratorⁱ | phr | 1.1 | 1.1 | 1.1 | 1.1 |
| Thiazole accelerator (MBT) | phr | 0.2 | — | 0.2 | — |
| Sulfur | phr | 1.8 | 1.8 | 1.8 | 1.8 |

^{a}Amino-functionalized and Sn-coupled SSBR, Nipol NS116, Nippon Zeon.
^{b}SSBR, Buna VSL 5025, Lanxess
^{c}N339
^{d}PEG carboxylic acid ester. Struktol AW 1, Schill & Seilacher
^{e}3-Mercaptopropyltriethoxysilane
^{f}TDAE
^{g}Aliphatic C5 resin
^{h}DTPD, 6PPD, antiozonant wax
ⁱBenzothiazyl-2-cyclohexylsulfenamide

TABLE 2a

| Constituents | Unit | C3 | C4 | I3 |
|---|---|---|---|---|
| Styrene-butadiene rubberⁱ | phr | 100 | 100 | 100 |
| Carbon blackⁱⁱ | phr | 60 | 60 | 60 |
| Amphiphilic compoundⁱⁱⁱ | phr | — | 2 | 2.1 |
| Silane^{iv} | phr | — | — | 0.72 |
| Plasticizer^{v} | phr | 19 | 19 | 19 |
| Zinc oxide | phr | 2.5 | 2.5 | 2.5 |
| Additional materials^{vi} | phr | 6 | 6 | 6 |
| Sulfenamide accelerator^{vii} | phr | 1.8 | 1.8 | 1.8 |
| Sulfur | phr | 2.2 | 2.2 | 2.2 |

ⁱSSBR, Buna VSL 5025, Lanxess
ⁱⁱN339
ⁱⁱⁱBrij 30, Dow Chemical
^{iv}Si263
^{v}TDAE
^{vi}TMQ, 6PPD, antiozonant wax
^{vii}Benzothiazyl-2-cyclohexylsulfenamide

TABLE 3a

| Constituents | Unit | C5 | I5 |
|---|---|---|---|
| Butadiene rubber^{a} | phr | 30 | 30 |
| Styrene-butadiene rubber^{b} | phr | 70 | 70 |
| Carbon black^{c} | phr | 70 | 70 |
| Amphiphilic compound^{d} | phr | — | 1.5 |
| Silane^{e} | phr | — | 0.7 |
| Plasticizer^{f} | phr | 25 | 25 |
| Zinc oxide | phr | 2.5 | 2.5 |
| Reinforcement resin^{g} | phr | 1 | 1 |
| Additional materials^{h} | phr | 4.5 | 4.5 |
| Sulfenamide acceleratorⁱ | phr | 1.1 | 1.1 |
| Thiazole accelerator (MBT) | phr | 0.2 | — |
| Sulfur | phr | 1.5 | 1.5 |

^{a}High Cis BR, Neocis BR, Polimeri
^{b}Coupled SSBR, Nipol NS210, Nippon Zeon
^{c}N339
^{d}PEG carboxylic acid ester, Struktol AW 1, Schill & Seilacher
^{e}3-Mercaptopropyltriethoxysilane
^{f}TDAE
^{g}Aliphatic C5 resin
^{h}DTPD, 6PPD, antiozonant wax
ⁱBenzothiazyl-2-cyclohexylsulfenamide

TABLE 4a

| Constituents | Unit | C6 | I6 | C7 | I7 |
|---|---|---|---|---|---|
| Natural rubber, TSR | phr | 50 | 50 | — | — |
| Butadiene rubber^{a} | phr | — | — | 30 | 30 |
| Styrene-butadiene rubber^{b} | phr | 50 | 50 | 70 | 70 |
| Carbon black^{c} | phr | 60 | 60 | 58 | 58 |
| Amphiphilic compound^{d} | phr | — | 1 | — | 1.4 |
| Silane^{e} | phr | — | 0.5 | — | 0.7 |
| Plasticizer^{f} | phr | 14 | 14 | 23 | 23 |
| Zinc oxide | phr | 3 | 3 | 3 | 3 |
| Additional materials^{g} | phr | 4.5 | 4.5 | 4.5 | 4.5 |
| Sulfenamide accelerator^{h} | phr | 1.1 | 1.1 | 1.1 | 1.1 |
| Thiazole accelerator (MBT) | phr | 0.2 | — | 0.2 | — |
| Sulfur | phr | 1.5 | 1.5 | 1.5 | 1.5 |

^{a}High Cis BR, Neocis BR, Polimeri
^{b}Coupled SSBR, Nipol NS210, Nippon Zeon
^{c}N339
^{d}PEG carboxylic acid ester, Struktol AW 1, Schill & Seilacher
^{e}3-Mercaptopropyltriethoxysilane
^{f}TDAE
^{g}DTPD, 6PPD, antiozonant wax
^{h}Benzothiazyl-2-cyclohexylsulfenamide

TABLE 5a

| Constituents | Unit | C8* | I8* | I9** |
|---|---|---|---|---|
| Natural rubber^{a} | phr | 50 | 50 | 50 |
| Styrene-butadiene rubber^{b} | phr | 50 | 50 | 50 |
| Carbon black^{c} | phr | 50 | 50 | 50 |
| Amphiphilic compound^{d} | phr | — | 2 | 2 |
| Silane^{e} | phr | — | 0.75 | 0.75 |
| Plasticizer^{f} | phr | 4 | — | — |
| Zinc oxide | phr | 3 | 3 | 3 |
| Additional materials^{g} | phr | 4.5 | 4.5 | 4.5 |
| Sulfenamide accelerator^{h} | phr | 1.1 | 1.1 | 1.1 |
| Sulfur | phr | 1.5 | 1.5 | 1.5 |

^{a}TSR
^{b}Amino-functionalized and Sn -coupled SSBR, Nipol NS116, Nippon Zeon
^{c}N339
^{d}PEG carboxylic acid ester, Struktol AW 1, Schill & Seilacher
^{e}3-Mercaptopropyltriethoxysilane
^{f}TDAE
^{g}DTPD, 6PPD, antiozonant wax
^{h}Benzothiazyl-2-cyclohexylsulfenamide
*All of the mixture constituents except the vulcanization system were mixed in one mixing stage, in a mixer
**NR/SSBR, carbon black, silane, and amphiphilic compound were mixed in a first mixing stage in a mixer, and all of the other constituents except the vulcanization system were added in a second mixing stage

In each of * and **, the vulcanization system was added in the final mixing stage.

TABLE 1b

| Property | Unit | C1 | I1 | C2 | I2 |
|---|---|---|---|---|---|
| Mooney viscosity | Mooney | 68.8 | 74.9 | 67.9 | 67 |
| Hardness | Shore A | 64.75 | 61.95 | 60.85 | 57.75 |
| Rebound at RT | % | 13.56 | 14.58 | 21.67 | 22.92 |
| Rebound at 70° C. | % | 40.85 | 47.71 | 51.23 | 56.06 |
| Delta rebound | % | 27.29 | 33.13 | 29.57 | 33.14 |
| Elongation at break | % | 352 | 326 | 339 | 338 |
| 50% stress value | MPa | 1.5 | 1.5 | 1.3 | 1.2 |
| tan δ | — | 0.26 | 0.23 | 0.22 | 0.19 |

TABLE2 b

| Property | Unit | C3 | C4 | I4 |
|---|---|---|---|---|
| Mooney viscosity | Mooney | 73.2 | 65.2 | 70.5 |
| Hardness | Shore A | 67 | 63 | 63 |
| Rebound at RT | % | 14.20 | 14.28 | 15.60 |
| Rebound at 70° C. | % | 41.91 | 43.84 | 50.37 |
| Delta rebound | % | 27.71 | 29.56 | 34.77 |
| Elongation at break | % | 395 | 365 | 340 |
| 50% stress value | MPa | 1.6 | 1.5 | 1.6 |
| tan δ | — | 0.24 | 0.24 | 0.19 |

TABLE 3b

| Property | Unit | C5 | I5 |
|---|---|---|---|
| Mooney viscosity | Mooney | 63.2 | 64.4 |
| Hardness | Shore A | 62 | 58 |
| Rebounnd at RT | % | 38.87 | 42.50 |
| Rebound at 70° C. | % | 48.65 | 52.12 |
| Delta rebound | % | 9.78 | 9.62 |
| Elongation at break | % | 414 | 482 |
| 50% stress value | MPa | 1.2 | 1.1 |

TABLE 4b

| Property | Unit | C6 | I6 | C7 | I7 |
|---|---|---|---|---|---|
| Mooney viscosity | Mooney | 71.5 | 65.6 | 57.3 | 58.1 |
| Hardness | Shore A | 60 | 57 | 60 | 59 |
| Rebound at RT | % | 38.05 | 41.39 | 37.60 | 42.03 |
| Rebound at 70° C. | % | 52.38 | 57.47 | 49.19 | 53.90 |
| Delta rebound | % | 14.33 | 16.08 | 11.59 | 11.87 |
| Elongation at break | % | 473 | 467 | 416 | 442 |
| 50% stress value | MPa | 1.2 | 1.2 | 1.2 | 1.2 |
| tan δ | — | 0.18 | 0.16 | 0.22 | 0.17 |

TABLE 5b

| Property | Unit | C8* | I8* | I9** |
|---|---|---|---|---|
| Mooney viscosity | Mooney | 67 | 59.5 | 62.9 |
| Hardness | Shore A | 60 | 59 | 60 |
| Rebound at RT | % | 35.53 | 33.56 | 35.02 |
| Rebound at 70° C. | % | 62.07 | 63.09 | 64.61 |
| Delta rebound | % | 26.54 | 29.53 | 29.59 |
| Elongation at break | % | 445 | 428 | 433 |
| 50% stress value | MPa | 1.3 | 1.3 | 1.3 |
| tan δ | — | 0.15 | 0.13 | 0.12 |

From Tables 1 to 5 it can be seen that, the rubber mixtures I1 to I9** of the invention offer a clear advantage in relation to the conflict of objectives between rolling resistance and wet grip, while the other physical properties remain at approximately the same level, or indeed in some cases are also improved. In particular, there is no impairment of elongation at break. Rolling resistance is represented here by taking rebound resilience at 70° C., and higher values here represent an improvement. Wet grip is illustrated by taking rolling resistance at room, temperature, and. lower values here represent an improvement. “Delta rebound” in turn gives the difference between the two rebound values. An increase in this difference generally means a better solution to the conflict of objectives between rolling resistance and wet grip. An increase in the elongation at break value indicates an improvement in elongation at break. However, a factor to be taken into account when the results are considered is that the intention is not to improve one property alone but instead to resolve, or at least mitigate, the conflict of objectives between properties that are usually inversely correlated, without any significant impairment of the other physical properties.

It is understood that the foregoing description is that of the preferred embodiments of the invention and that various changes and modifications may be made thereto without departing from the spirit said scope of the invention as defined in the appended claims.

What is claimed is:

1. A rubber mixture comprising;
at least, one synthetic diene rubber;
at least one carbon black;
at least one silane; and,
at least one amphiphilic compound.

2. The rubber mixture as claimed in claim 1, wherein the synthetic diene rubber is a solution-polymerized styrene-butadiene rubber.

3. The rubber mixture as claimed in claim 1, wherein the amounts used of the silane are from 0.3 to 5 phr.

4. The rubber mixture as claimed in claim 1, wherein the silane is a mercaptosilane.

5. The rubber mixture as claimed in claim 1, comprising from 0.5 to 10 phr of at least one amphiphilic compound.

6. The rubber mixture as claimed in claim 1, wherein the amphiphilic compound is an anionic surfactant, or a nonionic surfactant, or a cationic surfactant, or an amphoteric surfactant, or a block copolymer,

7. The rubber mixture as claimed in claim 6, wherein the block copolymer is a poloxamer.

8. The rubber mixture as claimed in claim 6, wherein the nonionic surfactant is a polyoxyethylene fatty acid ester.

9. A method of producing a tire, comprising preparing a rubber mixture as claimed in claim 1.

10. The method as claimed in claim 9 for producing the tread and/or a body mixture of a tire.

11. The method as claimed in claim 1 for producing a belt, a strap or a hose.
